(19) United States
(12) Patent Application Publication
(10) Pub. No.: US 2022/0276642 A1
(43) Pub. Date: Sep. 1, 2022

(54) ALLOCATION DEVICE, LEARNING DEVICE, INFERENCE DEVICE, ALLOCATION METHOD, AND NON-TRANSITORY COMPUTER READABLE MEDIUM

(71) Applicant: MITSUBISHI ELECTRIC CORPORATION, Tokyo (JP)

(72) Inventor: Daisuke OSAGAWA, Tokyo (JP)

(73) Assignee: MITSUBISHI ELECTRIC CORPORATION, Tokyo (JP)

(21) Appl. No.: 17/749,810

(22) Filed: May 20, 2022

Related U.S. Application Data
(63) Continuation of application No. PCT/JP2020/002720, filed on Jan. 27, 2020.

(51) Int. Cl. G05B 19/418

(52) U.S. Cl. CPC G05B 19/41835; G05B 19/41865; G05B 19/4185

(57) ABSTRACT

An allocation device (100) includes an allocation consideration unit (150) to find a value obtained by arithmetic operation on a base, the value being a natural number equal to or less than a value obtained by dividing each of a plurality of communication intervals by a value equal to or more than an evaluation cycle, as a plurality of evaluation frequencies respectively corresponding to the plurality of communication intervals, to set a plurality of communication frequencies respectively corresponding to the plurality of communication intervals as once in a cycle indicated by each of the plurality of evaluation frequencies, and to determine a communication plan, the communication plan indicating a period in which a communication of each of the plurality of communication types is performed, by allocating a cycle number identifying a cycle to any one communication type of a plurality of communication types, thereby performing an allocation process.

### CROSS REFERENCE TO RELATED APPLICATIONS

This application is a Continuation of PCT International Application No. PCT/JP2020/002720, filed on Jan. 27, 2020, which is hereby expressly incorporated by reference into the present application.

### TECHNICAL FIELD

The present invention relates to an allocation device, allocation method, learning device, inference device, and allocation program.

### BACKGROUND ART

In an FA (Factory Automation) network, it is general that communication time is allocated to each of realtime communication and non-realtime communication for cyclic communication. Here, it is necessary to design a communication timing so that realtime communication falls within the allocated communication time. The communication timing governs which frame is to be transmitted in which communication cycle.

Patent Literature 1 discloses a method of performing the same realtime communication in any communication cycle based on designed communication timing.

### CITATION LIST

### Patent Literature

Patent Literature 1: JP 2007-081628 A1

### SUMMARY OF INVENTION

### Technical Problem

In the method of Patent Literature 1, since the same realtime communication is performed in any communication cycle, realtime communication with a required communication interval longer than twice as long as the communication cycle performs not-required communication. Thus, there is a problem that a ratio of non-realtime communication time reduces more than required.

An object of the present invention is to reduce a ratio of realtime communication time by designing a communication timing in accordance with a required communication interval.

### Solution to Problem

An allocation device according to the present invention comprises:
a storage unit having stored therein a base having a positive value, a plurality of communication types indicating types of cyclic communications, a plurality of communication intervals respectively indicating, for each of the plurality of communication types, upper limits of intervals in which two successive communications are performed, and an evaluation cycle indicating a communication cycle candidate in a communication plan indicating a period in which a communication of each of the plurality of communication types is performed; and
an allocation consideration unit to find a value obtained by arithmetic operation on the base, the value being a natural number equal to or less than a value obtained by dividing each of the plurality of communication intervals by a value equal to or more than the evaluation cycle, as a plurality of evaluation frequencies respectively corresponding to the plurality of communication intervals, to set a plurality of communication frequencies respectively corresponding to the plurality of communication intervals as once in a cycle indicated by each of the plurality of evaluation frequencies, and to determine the communication plan by allocating a cycle number identifying a cycle to any one communication type of the plurality of communication types, thereby performing an allocation process.

### Advantageous Effects of Invention

According to an allocation device 100 of the present invention, an allocation consideration unit 150 finds a value obtained by arithmetic operation on the base, the value being a natural number equal to or less than a value obtained by dividing each of a plurality of communication intervals by a value equal to or more than the evaluation cycle, as a plurality of evaluation frequencies respectively corresponding to the plurality of communication intervals. The allocation consideration unit 150 sets a plurality of communication frequencies respectively corresponding to the plurality of communication intervals as once in a cycle indicated by each of the plurality of evaluation frequencies. The allocation consideration unit 150 allocates a cycle number identifying a cycle to any one communication type of the plurality of communication types. Then, the allocation consideration unit 150 performs an allocation process of determining a communication plan indicating a period in which a communication of each of the plurality of communication types is performed.

Thus, according to the allocation device 100 of the present invention, the ratio of realtime communication time can be reduced.

### BRIEF DESCRIPTION OF DRAWINGS

FIG. 1 is a diagram illustrating cyclic communication.

FIG. 2 is a diagram illustrating communication time for realtime communication and communication time for non-realtime communication.

FIG. 3 is a diagram for specifically describing that the communication cycle is divided by X.

FIG. 4 is a diagram for specifically describing that the communication cycle is divided by X.

FIG. 5 is a diagram for specifically describing that the communication ratio decreases.

FIG. 6 is a diagram of the structure of an allocation device 100 according to Embodiment 1.

FIG. 7 is a diagram of the hardware structure of the allocation device 100 according to Embodiment 1.

FIG. 8 is a flowchart illustrating the operation of the allocation device 100 according to Embodiment 1.

FIG. 9 is a diagram illustrating the results of performing a cycle determination process according to Embodiment 1.

FIG. 10 is a diagram illustrating the results of performing the cycle determination process according to Embodiment 1.

FIG. 11 is a flowchart illustrating the operation of an allocation consideration unit 150 according to Embodiment 1.

FIG. 12 is a diagram for specifically describing the operation of the allocation consideration unit 150 according to Embodiment 1.

FIG. 13 is a diagram of the hardware structure of the allocation device 100 according to a modification example of Embodiment 1.

FIG. 14 is a diagram of the structure of an allocation system 90 according to Embodiment 2.

FIG. 15 is a diagram of the structure of the allocation device 100 according to Embodiment 2.

FIG. 16 is a diagram of the hardware structure of the allocation device 100 according to Embodiment 2.

FIG. 17 is a diagram of the structure of a learning device 200 according to Embodiment 2.

FIG. 18 is a diagram of the hardware structure of the learning device 200 according to Embodiment 2.

FIG. 19 is a diagram of the structure of a learned model storage unit 400 according to Embodiment 2.

FIG. 20 is a diagram of the hardware structure of the learned model storage unit 400 according to Embodiment 2.

FIG. 21 is a flowchart illustrating the operation of the learning device 200 according to Embodiment 2.

FIG. 22 is a diagram of the structure of an inference device 300 according to Embodiment 2.

FIG. 23 is a diagram of the hardware structure of the inference device 300 according to Embodiment 2.

FIG. 24 is a flowchart illustrating the operation of the inference device 300 according to Embodiment 2.

### DESCRIPTION OF EMBODIMENTS

### Embodiment 1

Prior to description of details of the present embodiment, the premise, general outline, and so forth of the present embodiment are described.

It is assumed that communication refers to realtime communication, unless otherwise specified.

### Requirements of Communication Cycle

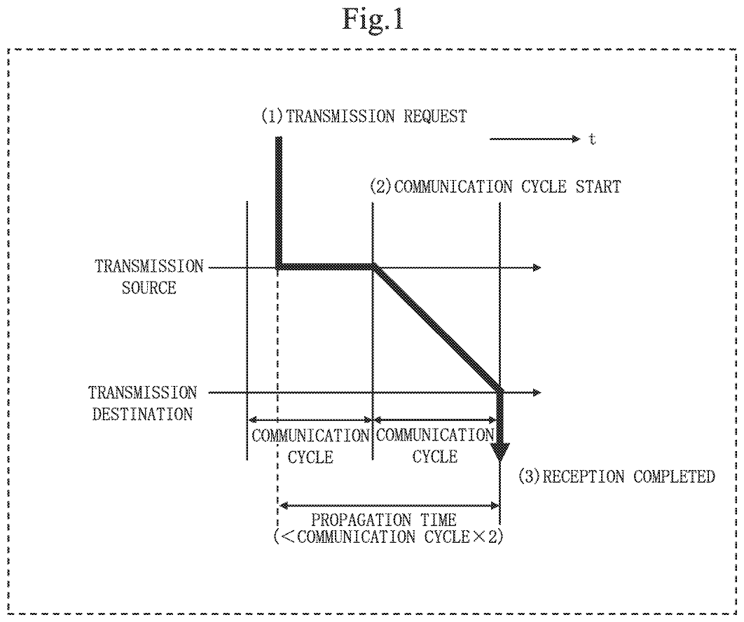

FIG. 1 is a diagram illustrating an example of cyclic communication.

The operation of a transmission source and a transmission destination in cyclic communication is described. The transmission source makes a frame transmission request based on a predetermined communication interval ((1) transmission request).

The transmission source starts frame transmission after a communication cycle immediately after (1) transmission request starts ((2) communication cycle start). The transmission destination completes reception of all transmitted frames ((3) reception completed).

Here, when the transmission source and the transmission destination normally operate, it is guaranteed that the transmission destination completes reception of all frames within one communication cycle.

The transmission source and the transmission destination may be any communication devices.

The communication cycle is a cycle of communication between the transmission source and the transmission destination, the cycle corresponding to cyclic communication.

The communication interval has a value defined for each communication type indicating a type of communication, is an upper limit of two successive transmission request intervals, and is an upper limit of an interval for performing two successive communications.

A time from (1) transmission request to (3) reception completed is assumed to a propagation time. A time from (1) transmission request to (2) communication cycle start is equal to or less than one communication cycle, and a time from (2) communication cycle start to (3) reception completed is equal to or less than one communication cycle. Thus, the propagation time is normally equal to or less than two communication cycles.

Also, the propagation time is required to be shorter than the communication interval. Thus, when the communication cycle is equal to or less than half of the shortest communication interval (Cyc_min), this satisfies the communication intervals of all communication types.

Note that the time from (2) communication cycle start to (3) reception completed is assumed to be equal to or less than Cyc_min/(2×X) in any communication cycle. Here, X is an integer equal to or less than 2, and has a given value.

### Cycle Number Allocation Method

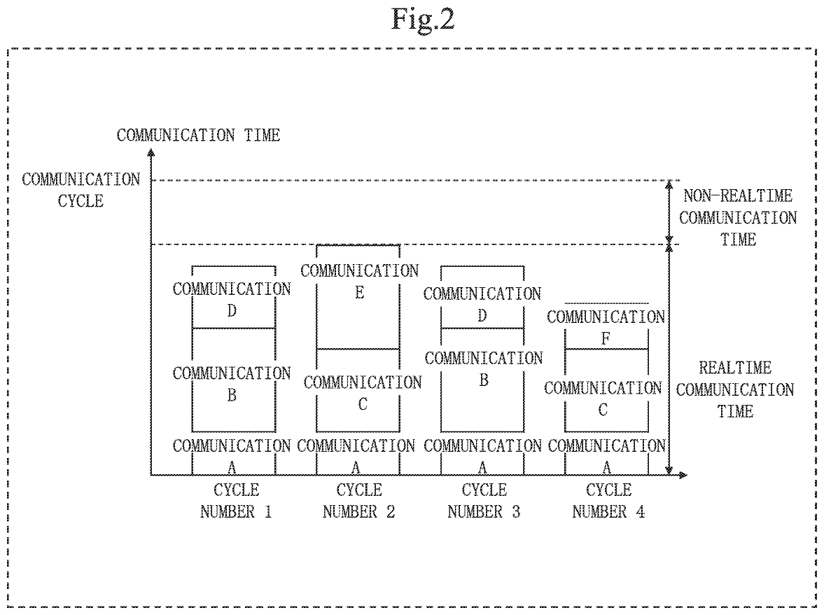

FIG. 2 illustrates an example of communication time for realtime communication and communication time for non-realtime communication. In the following, an allocation method of allocating a communication type to a cycle number is described by using the drawing.

“Communication A” or the like represents a communication type. A communication time is a time required for one communication and, typically, is a time from (2) communication cycle start to (3) reception completed. The communication time may also refer to a time required for one communication of one communication type. A time required for all communications in a cycle may also be represented as a total of communication times.

The cycle number is, for example, a number capable of identifying a cycle and, typically, is a number sequentially allocated to a communication cycle in a manner such that 1 is allocated to a communication cycle and 2 is allocated to a communication cycle next to the communication cycle corresponding to the cycle number 1. In the following, allocating a cycle number to a communication type, that is, determining a cycle in which a communication of a communication type is performed, is represented as number allocation.

In all communication cycles, as a communication time for realtime communication, a time for realtime communication in a communication cycle with the longest communication time for realtime communication is allocated. As a communication time for non-realtime communication, a time obtained by subtracting the time for realtime communication from the time of one cycle is allocated. In each cycle, a time allocated as a time for realtime communication is referred to as a realtime communication time.

When a plurality of communications each having a communication frequency indicating once in N cycles (hereinafter, communication frequency N) are allocated to cycle numbers, if communications are allocated sequentially from those with longer communication time to communication cycles with shorter communication time for realtime communication, the communication times of the respective cycles can be smoothed. Thus, a ratio of occupation of the communication time for realtime communication can be decreased.

Communications of communication types with different communication frequencies may overlap in any communication cycle to cause concentration of realtime communications and, as a result, an increase in communication ratio. To avoid this, there is a method of checking communication overlapping in a range of M cycle. The communication ratio is a maximum value of a ratio of a total of communication times for realtime communications occupying the time of one cycle, and is a ratio of occupation of the communication time for realtime communication in each communication cycle. M is a least common multiple for all N corresponding to the communication frequency. In the following, a range in which the allocation device 100 checks communication overlapping is assumed to be a system communication cycle. The communication frequency is a frequency of performing communication, and is defined for each communication type.

When this method is used, if the system communication cycle is increased, the cycle to be checked may become enormous. As means for solving this, in the description of the embodiment, a method of providing a constraint that the communication frequency N is a power of a base X is described. By providing this constraint, the system communication cycle matches the communication frequency of a communication type with the lowest communication frequency. Thus, the allocation device 100 can reduce the range of checking communication overlapping.

When the communication frequency is a power of the base X and a communication type to be performed once in X\hat{ }i cycles is allocated to a cycle number ((X\hat{ }i)×n+j), to allocate a communication to be performed once in X\hat{ }(i−1) cycles so as to avoid overlapping with the cycle number ((X\hat{ }i)×n+j), the communication is required to be allocated to a cycle number ((X\hat{ }(i−1))×n+k). Here, it is assumed that n is an integer equal to or more than 0, i is an integer equal to or more than 2, j is an integer and 1≤j≤X\hat{ }i, k is an integer and 1≤k≤X\hat{ }(i−1), and the remainder of division of k by X\hat{ }(i−1) and the remainder of division of j by X\hat{ }(i−1) do not match. In the following, when variable names are identical, the constraint of variable values are the same, unless otherwise specified.

That is, communications allocated only to a cycle number ((X\hat{ }i)×n+(X\hat{ }(i−1))×l+j) (where l is an integer equal to or more than 1 and less than X) while avoiding overlapping with the cycle number ((X\hat{ }i)×n+j) are limited to communications to be performed once in X\hat{ }i cycles or more.

Thus, it is possible to add a procedure of allocating a communication to be performed once in X\hat{ }i cycles or more to the allocation method so that after a communication with a long communication time is allocated to a communication cycle with a short realtime communication time ((X\hat{ }i)×n+j), a realtime communication time of the cycle number ((X\hat{ }i)×n+(X\hat{ }(i−1))×l+j) is equal to or smaller than the realtime communication time of the communication cycle ((X\hat{ }i)×n+j). Note that the procedure of allocating a communication to be performed once in X\hat{ }(i+1) cycles or more is recursive.

### Communication Cycle Calculation Method

When a constraint that the communication frequency is a power of the base X (hereinafter, a power constraint) is provided, consider a case in which the communication cycle is shortened from t to t/X.

It is assumed that a communication ratio is rₜ when the communication cycle is t and a communication ratio is rₜ/x when the communication cycle is t/X.

When the communication cycle is shortened to t/X, if the communications allocated to each cycle number are equally divided by X, rₜ is equal to rₜ/x. However, rₜ/x is larger than rₜ unless communications allocated to each cycle number are equally divided by X.

Equally dividing communications by X means that communications are equally divided by X when communications in a communication cycle can be equally divided by X and the communications equally divided by X are each allocated to a different communication cycle.

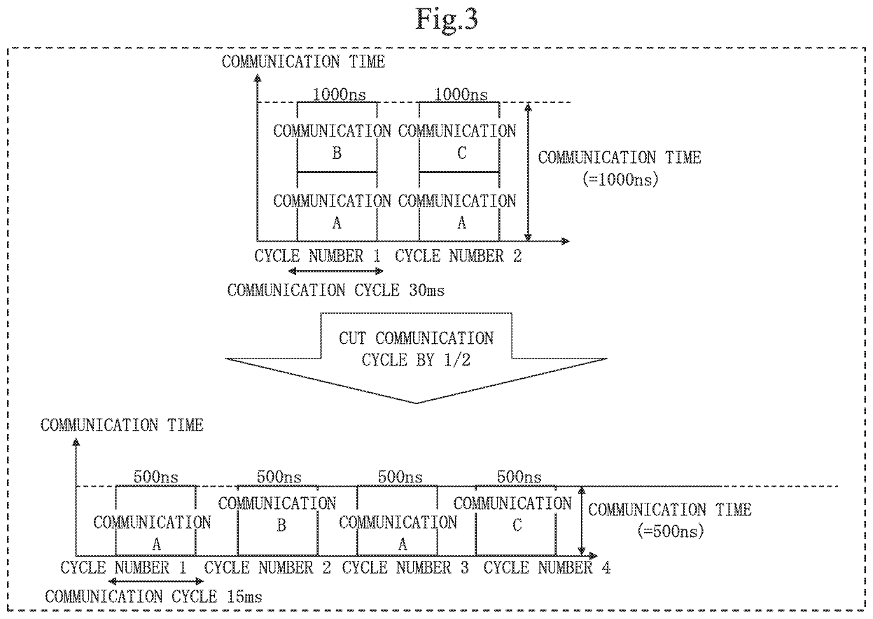

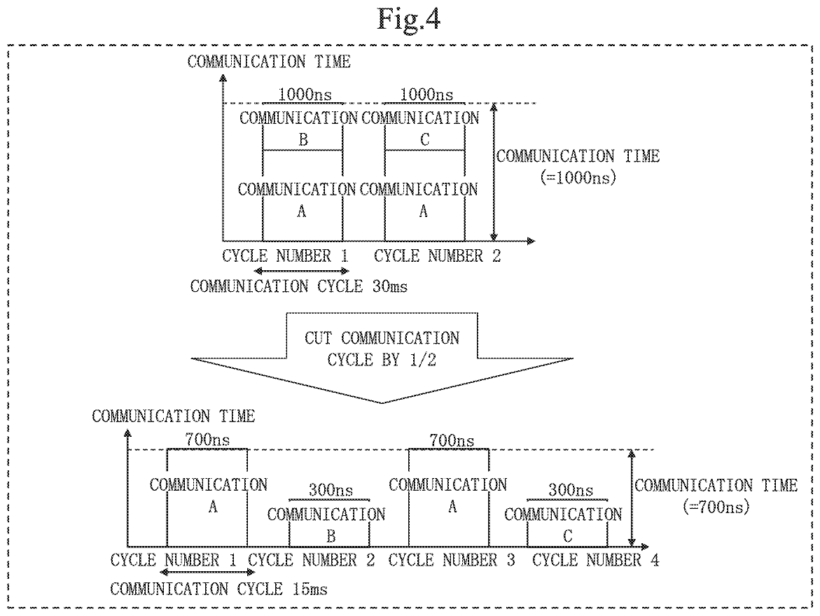

FIG. 3 and FIG. 4 are diagrams for specifically describing that the communication cycle is divided by X. Note that X is 2 in these drawings.

In an example illustrated in FIG. 3, the communication cycle is shortened from 30 ms to 15 ms and, at the same time, communications allocated to each cycle number are equally divided by two. Therefore, the communication ratio is the same in either communication cycle.

In an example illustrated in FIG. 4, the communication cycle is shortened from 30 ms to 15 ms and, at the same time, communications allocated to each cycle number are not equally divided into two. Therefore, as a result of shortening the communication cycle, the communication ratio increases. In the present example, communications allocated to each cycle number cannot be equally divided into two.

When communications cannot be equally divided by X, communications cannot be equally divided by X\hat{ }i, either. From this, in searching for an optimum communication cycle, it can be found that it is sufficient to search a range of communication cycles equal to or less than t and equal to or more than t/X.

Consider a case in which the communication cycle is tried to be shortened. The communication ratio basically increases as the communication cycle becomes shortened. However, in consideration of the power constraint, the communication ratio decreases at the time when the communication cycle matches a value obtained by dividing a communication interval for a communication by the power of X.

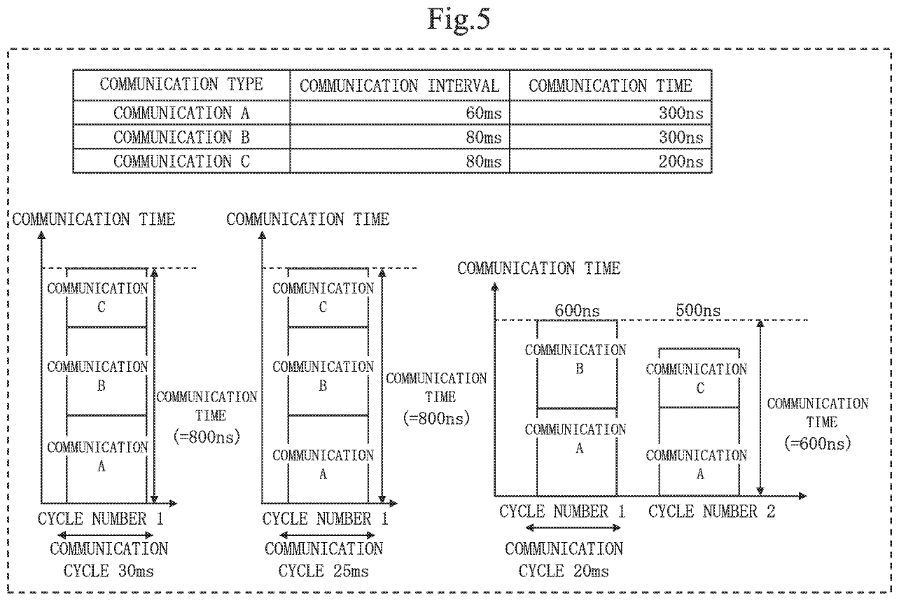

FIG. 5 is a diagram for specifically describing that the communication ratio decreases. Note that X is 2 in the drawing.

In the drawing, when the communication cycle is changed from 30 ms to 25 ms, the communication ratio increases. However, when the communication cycle is changed from 25 ms to 20 ms, the communication ratio decreases.

Therefore, the allocation device 100 takes a value obtained by dividing a communication interval of each communication by the power of the base as a communication cycle candidate and compares communication ratios of realtime communication in the respective communication cycles, and can thereby calculate an optimum communication cycle. Here, consider that the allocation device 100 has to take a communication cycle equal to or less than Cyc_min/2. Thus, the allocation device 100 finds a communication cycle candidate in a range equal to or more than Cyc_min/(2×X) and equal to or less than Cyc_min/2.

In the following, the present embodiment is described in detail with reference to the drawings.

### Description of Structure

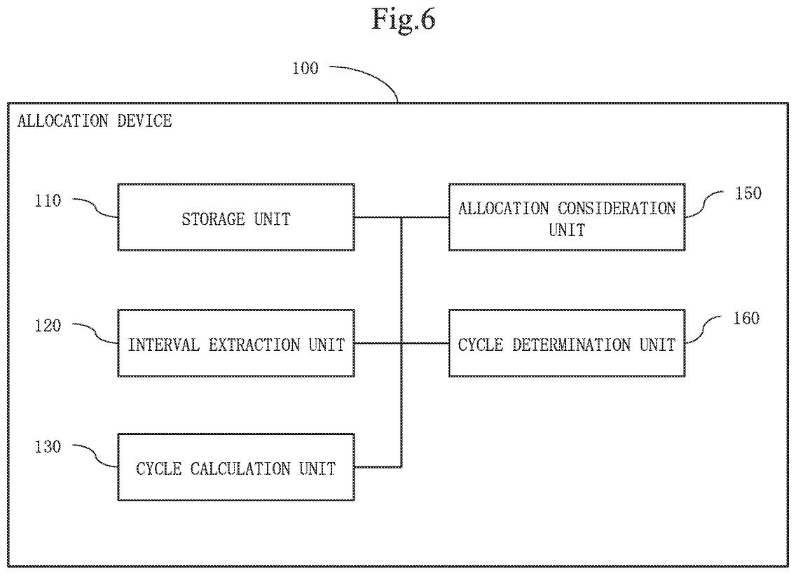

FIG. 6 illustrates an example of structure of the allocation device 100 according to the present embodiment.

As illustrated in the drawing, the allocation device 100 includes a storage unit 110, an interval extraction unit 120, a cycle calculation unit 130, an allocation consideration unit 150, and a cycle determination unit 160.

Each unit of the allocation device 100 causes the found result to be stored in the storage unit 110 and reads required data from the storage unit 110, unless otherwise specified.

Before the start of operation of the allocation device 100, the storage unit 110 has stored therein a plurality of communication intervals and a plurality of communication times respectively corresponding to a plurality of communication types to be subjected to number allocation.

The storage unit 110 has stored therein a base, the plurality of communication types, the plurality of communication intervals, and an evaluation cycle. The base has a positive value. The communication type indicates a type of cyclic communication. The plurality of communication intervals indicate, for each of the plurality of communication types, an upper limit of an interval in which two successive communications are performed. The evaluation cycle indicates a communication cycle candidate in a communication plan. That is, the evaluation cycle is a time per cycle in the communication plan. The communication plan indicates a period in which a communication of each communication type is performed.

The storage unit 110 may have stored therein a plurality of evaluation cycles.

The storage unit 110 may have stored therein an integer equal to or more than 2 as a base and a plurality of communication times each indicating a time required for one communication of each of the plurality of communication types.

The storage unit 110 may have stored therein a plurality of evaluation cycles.

The cycle calculation unit 130 may take a base as X and a minimum value of a plurality of communication intervals as Cyc_min. The cycle calculation unit 130 may calculate, as an evaluation cycle, a value obtained by dividing each of the plurality of communication intervals by a power of X, the value being equal to or more than Cyc_min/(X×2) and equal to or less than Cyc_min/2.

The allocation consideration unit 150 finds values obtained by arithmetic operation on the base, the values being natural numbers equal to or less than a value obtained by dividing each of a plurality of communication intervals by a value equal to or more than the evaluation cycle, as a plurality of evaluation frequencies respectively corresponding to the plurality of communication intervals. The allocation consideration unit 150 sets a plurality of communication frequencies respectively corresponding to the plurality of communication intervals as once in the cycle indicated by each of the plurality of evaluation frequencies. By allocating a cycle number identifying a cycle to any one communication type of the plurality of communication types, the allocation consideration unit 150 determines a communication plan. That is, the allocation consideration unit 150 performs an allocation process.

Before performing an allocation process, the allocation consideration unit 150 performs a pre-allocation process of allocating a cycle number to a communication type in which the communication frequency is once in one cycle. In the allocation process, the allocation consideration unit 150 may handle only a communication type corresponding to a communication frequency in which a cycle indicated by the communication frequency is equal to or more than 2.

The allocation consideration unit 150 may set successive cycle numbers to successive cycles. The allocation consideration unit 150 may use, as a cycle number, a value equal to or more than 1 and equal to or less than a maximum value of all cycles indicated by the plurality of evaluation frequencies, respectively, to take all of the cycles set with the cycle numbers as target cycles.

In the allocation process, as a plurality of evaluation frequencies, the allocation consideration unit 150 may find a maximum value of values each being a power of the base and being equal to or less than a value obtained by dividing each of the plurality of communication intervals by a double of the evaluation cycle. From among communication types corresponding to the maximum value of the plurality of communication times, the allocation consideration unit 150 may extract, as a target communication, a communication type with a maximum communication frequency corresponding to the communication type. In a range which j and n can take, from among cycles with the cycle number being C×n+j, the allocation consideration unit 150 may extract, as Dⱼ, a communication time of a cycle with the longest communication time. Here, it is assumed that a cycle indicated by a communication frequency corresponding to a target communication is C, j is an integer and 1≤j≤C, and n is an integer equal to or more than 0. The allocation consideration unit 150 may take, as jₘᵢₙ, j corresponding to the minimum value of Dⱼ in a range which j can take and may extract, as an allocation-target communication, a communication type with no cycle number allocated. The allocation consideration unit 150 may allocate, as a cycle number, C×n+jₘᵢₙ to the allocation-target communication.

After performing the allocation process, the allocation consideration unit 150 may perform a post-allocation process. In the post-allocation process, the allocation consideration unit 150 may take, as a selected type, any communication type with a cycle being equal to or more than X\hat{ }i and with no cycle number allocated and may allocate, as a cycle number, (X\hat{ }i)×n+X\hat{ }(i−1)+jₘᵢₙ to the selected type. Here, it is assumed that n is an integer equal to or more than 0, i is an integer equal to or more than 2, C is X\hat{ }i, k is an integer and 1≤k≤X\hat{ }(i−1), and the remainder of division of k by X\hat{ }(i−1) and the remainder of division of j by X\hat{ }(i−1) do not match.

In the post-allocation process, the allocation consideration unit 150 may allocate a cycle number to the selected type so that the total of communication times does not exceed a maximum value of a total of communication times of cycles with the cycle number being (X\hat{ }i)×n+jₘᵢₙ in a range which n can take.

When the target cycles are configured of a plurality of cycles, the cycle determination unit 160 may find, as a plurality of provisional communication ratios, a ratio of a total of communication times occupying a time of one cycle of each cycle configuring each of the target cycles, for each of the plurality of evaluation cycles, based on the cycle numbers allocated to the plurality of communication types, respectively. The cycle determination unit 160 finds, as a plurality of communication ratios, maximum values of the plurality of provisional communication ratios for each of the plurality of evaluation cycles. The cycle determination unit 160 may take an evaluation cycle corresponding to a minimum value of the plurality of communication ratios as a communication cycle of the communication plan.

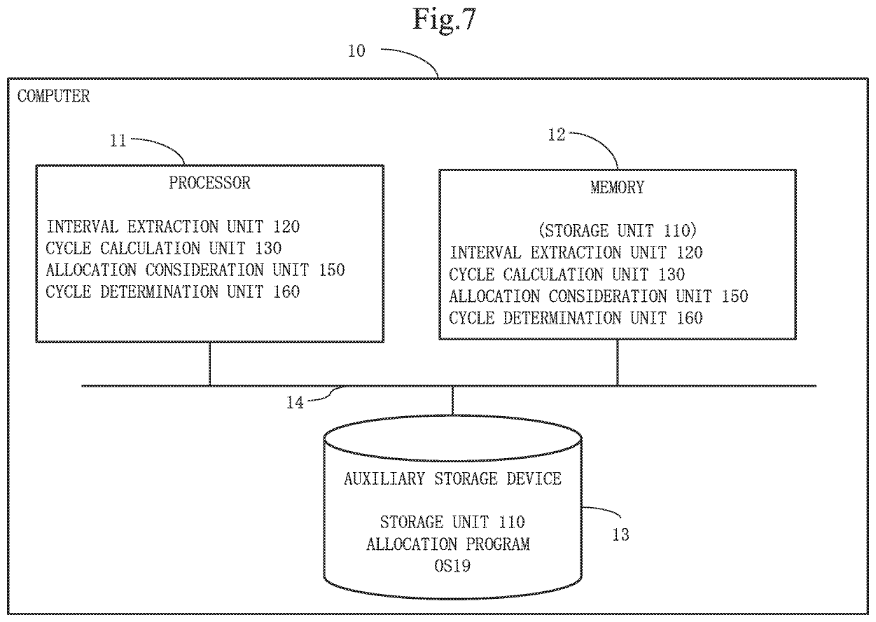

FIG. 7 illustrates an example of hardware structure of the allocation device 100 according to the present embodiment.

The allocation device 100 is configured of a general computer 10. The allocation device 100 may be configured of a plurality of computers 10.

A processor 11 is a processing device which executes an allocation program, an OS (Operating System) 19, and so forth. The processing device may also be referred to as an IC (Integrated Circuit). As a specific example, the processor 11 is a CPU (Central Processing Unit), DSP (Digital Signal Processor), or GPU (Graphics Processing Unit).

The processor 11 is connected to a memory 12 via a data bus 14, performs, for example, temporary storage of data required for arithmetic operation, and reads and executes a program stored in the memory 12.

While the computer 10 of the drawing includes only one processor 11, the computer 10 may include a plurality of processors which replaces the processor 11. The plurality of these processors share the role of program execution and so forth.

The memory 12 is a storage device which temporarily stores data, can retain the arithmetic operation result of the processor 11, and functions as a main memory to be used as a working area of the processor 11. The memory 12 can store a program corresponding to each unit of the allocation device 100. The programs stored in the memory 12 are developed to the processor 11.

As a specific example, the memory 12 is a RAM (Random Access Memory) such as SRAM (Static Random Access Memory) or DRAM (Dynamic Random Access Memory).

At least part of the storage unit 110 may be configured of an auxiliary storage device 13.

The auxiliary storage device 13 has stored therein an allocation program, various programs to be executed by the processor 11, data to be used at the time of execution of each program, the OS 19, and so forth. The storage unit 110 is configured of the auxiliary storage device 13.

As a specific example, the auxiliary storage device 13 is an HDD (Hard Disk Drive) or SSD (Solid State Drive). Also, the auxiliary storage device 13 may be a portable recording medium such as a memory card, SD (Secure Digital, registered trademark) memory card, NAND flash, or DVD (Digital Versatile Disk).

The OS 19 is loaded by the processor 11 from the auxiliary storage device 13, developed onto the memory 12, and executed on the processor 11. The OS 19 may be any compatible with the processor 11.

The OS 19 and the allocation program may be stored in the memory 12.

The allocation program may be provided as a program product.

### Description of Operation

The operation procedure of the allocation device 100 corresponds to the allocation method. Also, a program implementing the operation of the allocation device 100 corresponds to the allocation program.

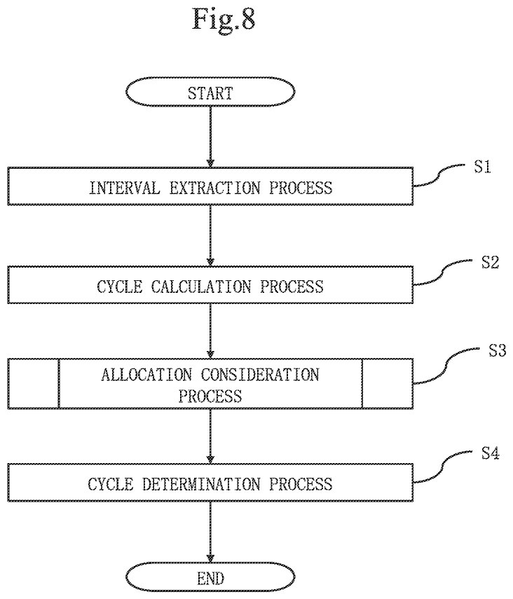

FIG. 8 illustrates a flowchart illustrating one example of operation of the allocation device 100.

### Step S1: Interval Extraction Process

The interval extraction unit 120 checks communication intervals of all communication types stored in the storage unit 110 and extracts Cyc_min.

### Step S2: Cycle Calculation Process

The cycle calculation unit 130 calculates, for each communication type, an evaluation cycle by using Cyc_min, the communication interval stored in the storage unit 110, and X. The evaluation cycle is a communication cycle candidate in the communication plan. The evaluation cycle has a value obtained by dividing the communication interval of a communication type by a power of X, the value being equal to or more than Cyc_min/(2×X) and equal to or less than Cyc_min/2. The communication plan indicates periods in which the communications of the plurality of communication types are each performed. The cycle calculation unit 130 causes the calculated evaluation cycle to be stored in the storage unit 110.

Note that a value of X is set before the process at this step starts. The value of X may be set by any scheme.

### Step S3: Allocation Consideration Process

The allocation consideration unit 150 performs calculation of a communication frequency and number allocation for each of all evaluation cycles. Details of the process at this step are described further below.

### Step S4: Cycle Determination Process

The cycle determination unit 160 calculates a communication ratio corresponding to each of all evaluation cycles by using the communication time, the evaluation cycle, and the result of number allocation at step S3. The cycle determination unit 160 takes an evaluation cycle corresponding to the lowest communication ratio as an optimum communication cycle.

The allocation device 100 may output the communication cycle and number allocation for each communication type to another device or the like as communication timing information for reducing the communication ratio.

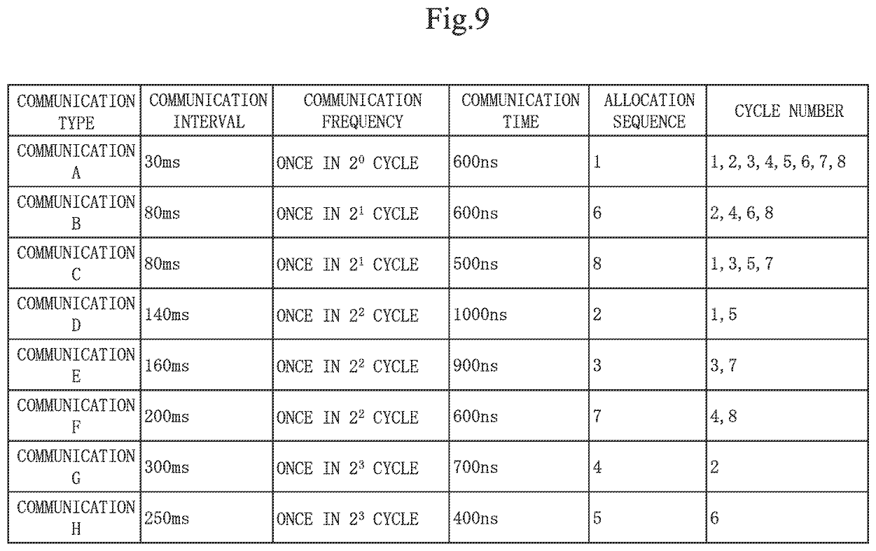

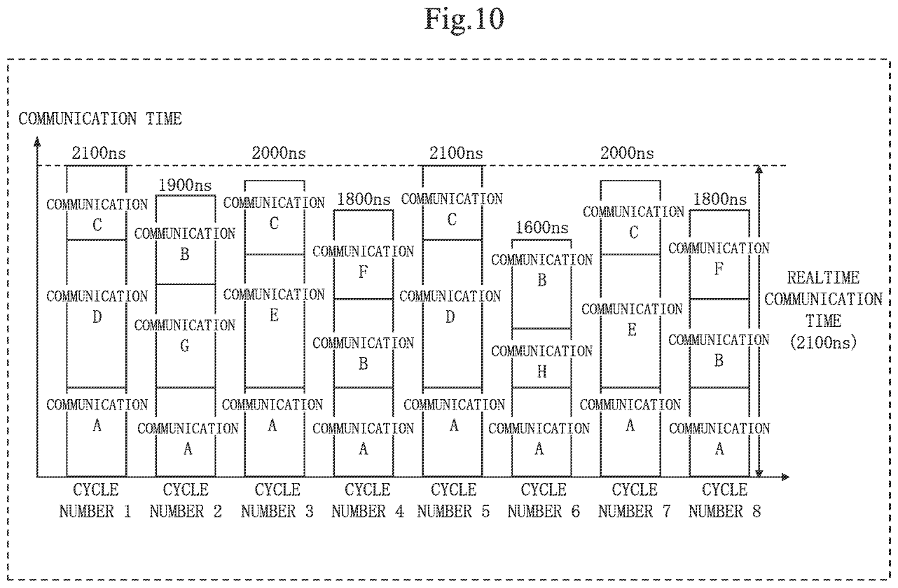

FIG. 9 and FIG. 10 are diagrams illustrating a specific example of the results of performing the process at this step. In the present example, X is 2, the communication cycle is 15 ms, and the system communication cycle is 120 ms. In a table of FIG. 9, the allocation sequence indicates the order in which cycle numbers are allocated at step S3, and the cycle number indicates the results of performing number allocation for each communication type.

These drawings represent communications in a range of one system communication cycle.

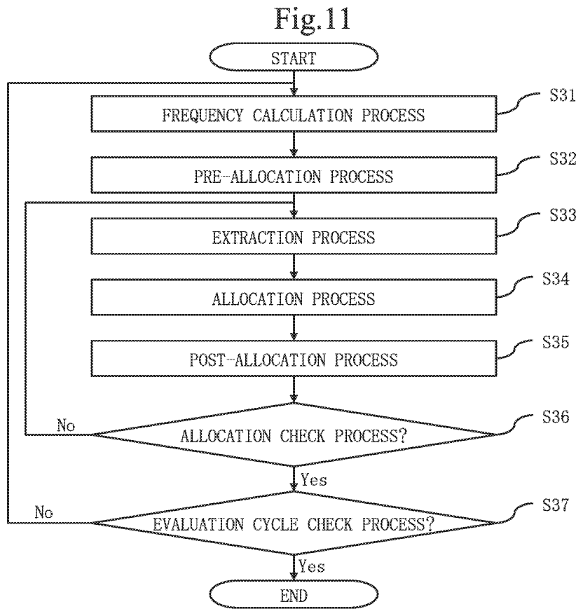

FIG. 11 illustrates one example of operation of the allocation consideration unit 150, illustrating a flowchart illustrating one example of the operation at step S3.

### Step S31: Frequency Calculation Process

The allocation consideration unit 150 selects one evaluation cycle, finds a maximum value of values each being a power of X and being equal to or less than a value obtained by dividing the communication interval by a double of the selected evaluation cycle (2×Cyc_ref), and sets a communication frequency as once in cycles of the found maximum value. Cyc_ref represents the evaluation cycle.

The allocation consideration unit 150 finds a plurality of evaluation frequencies respectively corresponding to a plurality of communication intervals. The plurality of evaluation frequencies have values obtained by arithmetic operation on the base, the values being natural numbers equal to or less than a value obtained by dividing each of the plurality of communication intervals by a value equal to or more than the evaluation cycle. The allocation consideration unit 150 sets the plurality of communication frequencies respectively corresponding to the plurality of communication intervals as once in the cycles indicated by each of the plurality of evaluation frequencies.

### Step S32: Pre-Allocation Process

The allocation consideration unit 150 allocates a communication in which the communication frequency is every cycle to all cycle numbers.

### Step S33: Extraction Process

From among communication types with no cycle number allocated and with the maximum communication time, the allocation consideration unit 150 extracts a communication with the maximum communication frequency. The communication with the maximum communication frequency is communicated most frequently.

In the following, in the description of this flowchart, it is assumed that the communication frequency of the communication type extracted at this step is X\hat{ }i.

### Step S34: Allocation Process

For all values which j can take, from among communication times with the cycle number being ((X\hat{ }i)×n+j), the allocation consideration unit 150 extracts one with the longest communication time and takes it as a communication time Dⱼ. The allocation consideration unit 150 sets j corresponding to minimum Dⱼ as jₘᵢₙ, and allocates the communication type extracted at step S33 to a cycle number ((X\hat{ }i)×n+jₘᵢₙ).

When a plurality of j with the minimum Dⱼ are present, the allocation consideration unit 150 sets any one value as jₘᵢₙ.

### Step S35: Post-Allocation Process

From among communication types which are communicated once in a cycle equal to or more than X\hat{ }i, the allocation consideration unit 150 selects, as a selected communication, a communication type with no cycle number allocated and with the maximum communication time. From among cycle numbers ((X\hat{ }i)×n+X\hat{ }(i−1)×l+jₘᵢₙ) in which a sum of the communication time of the cycle number ((X\hat{ }i)×n+X\hat{ }(i−1)×l+jₘᵢₙ) and the communication time of the selected communication does not exceed a maximum communication time of the cycle number ((X\hat{ }i)×n+jₘᵢₙ), the allocation consideration unit 150 allocates the selected communication to the cycle number ((X\hat{ }i)×n+X\hat{ }(i−1)×l+jₘᵢₙ) with the maximum communication time.

The allocation consideration unit 150 recursively performs the process at this step. When cycle numbers to be allocated run out, the allocation consideration unit 150 proceeds to step S36.

The allocation consideration unit 150 may select, as a selected communication, any communication type as long as it is a communication type communicated once in a cycle equal to or more than X\hat{ }i.

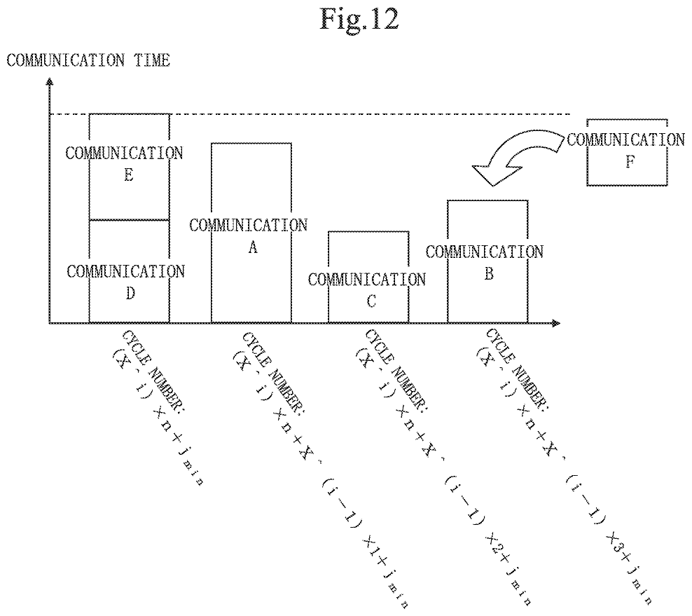

FIG. 12 is a diagram for describing one example of a process by the allocation consideration unit 150 allocating the selected communication to a cycle number. With reference to this drawing, this process is specifically described. A communication F is a selected communication. In the description of the present example, a maximum communication time of the cycle number ((X\hat{ }i)×n+jₘᵢₙ) is referred to as a maximum allocation time. In the present example, the maximum allocation time is a sum of the communication time of a communication D and the communication time of a communication E.

A sum of the communication time of a communication A and the communication time of the communication F exceeds the maximum allocation time. A sum of the communication time of a communication B and the communication time of the communication F does not exceed the maximum allocation time. A sum of the communication time of a communication C and the communication time of the communication F does not exceed the maximum allocation time. Also, the communication time of the communication B is longer than the communication time of the communication C.

Therefore, the allocation consideration unit 150 allocates the communication F to a cycle number ((X\hat{ }i)×n+X\hat{ }(i−1)×3+jₘᵢₙ) corresponding to the communication B.

### Step S36: Allocation Check Process

If number allocation has been performed on all communication types, the allocation consideration unit 150 proceeds to step S37.

Otherwise, the allocation consideration unit 150 proceeds to step S33.

### Step S37: Evaluation Cycle Check Process

If all evaluation cycles have been selected, the allocation consideration unit 150 ends the process in this flowchart. Otherwise, the allocation consideration unit 150 proceeds to step S31.

### Description of Effects of Embodiment 1

As described above, according to the present embodiment, the allocation device 100 allocates a cycle number based on the communication frequency so as to utilize a band. Thus, the allocation device 100 can smooth the communication times with the respective communication frequencies, and can reduce the communication ratio of realtime communication. Also, by restricting the communication frequency N to a power of a base X and making comparison of only the communication cycles with a decreasing ratio of realtime communication time, the allocation device 100 can simplify allocation of cycle numbers and calculation of an optimum communication cycle.

### Other Structures

### Modification Example 1

In the present embodiment, description has been made to a case in which each functional component is implemented by software. However, as a modification example, each functional component may be implemented by hardware.

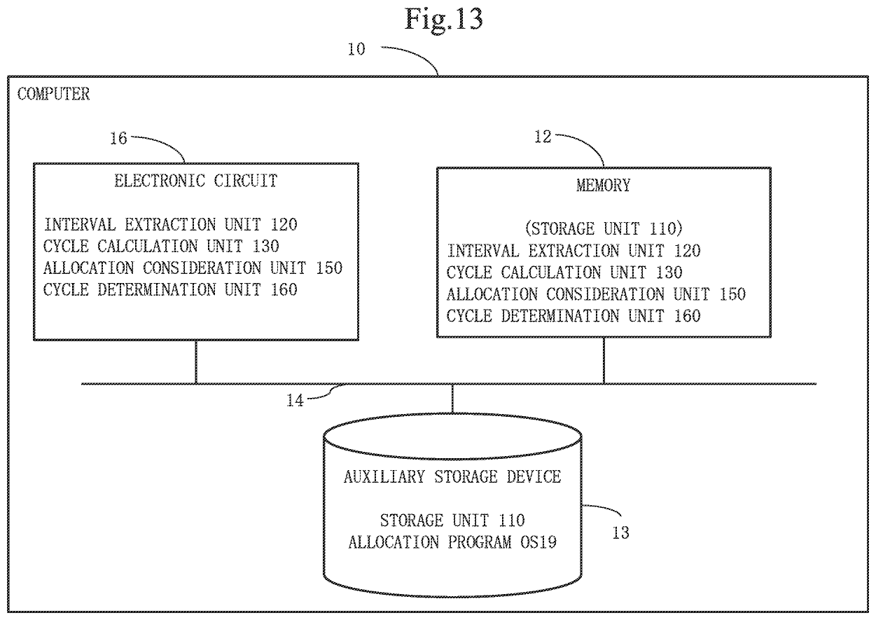

FIG. 13 illustrates an example of structure of the present modification example. When each functional component is implemented by hardware, as illustrated in the drawing, the allocation device 100 includes an electronic circuit 16 in place of the processor 11. Alternatively, although not illustrated, the allocation device 100 includes the electronic circuit 16 in place of the processor 11, the memory 12, and the auxiliary storage device 13. The electronic circuit 16 is a dedicated electronic circuit which implements the function of each functional component (and the memory 12 and the auxiliary storage device 13). An electronic circuit may be referred to as a processing circuit.

The electronic circuit 16 is assumed to be a single circuit, composite circuit, programmed processor, parallel-programmed processor, logic IC, GA (Gate Array), ASIC (Application Specific Integrated Circuit), or FPGA (Field-Programmable Gate Array).

Each of the functional components may be implemented by the single electronic circuit 16 or each of the functional components may be implemented as being dispersed into a plurality of electronic circuits 16.

Alternatively, part of each of the functional components may be implemented by hardware and each of the other functional components may be implemented by software.

The above-described processor 11, memory 12, auxiliary storage device 13, and electronic circuit 16 are collectively referred to as “processing circuitry”. That is, the function of each functional component is implemented by the processing circuitry.

### Embodiment 2

In the following, points different from the above-described embodiment are described in detail with reference to the drawings.

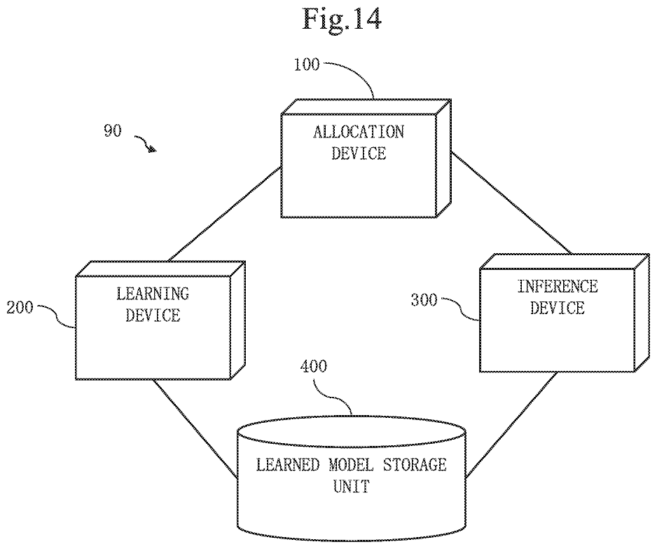

FIG. 14 illustrates an example of structure of an allocation system 90 according to Embodiment 2. As illustrated in the drawing, the allocation system 90 includes an allocation device 100, a learning device 200, an inference device 300, and a learned model storage unit 400.

### Learning Phase

In the following, a learning phase is described. The learning phase is a process to be performed by the learning device 200.

### Description of Structure

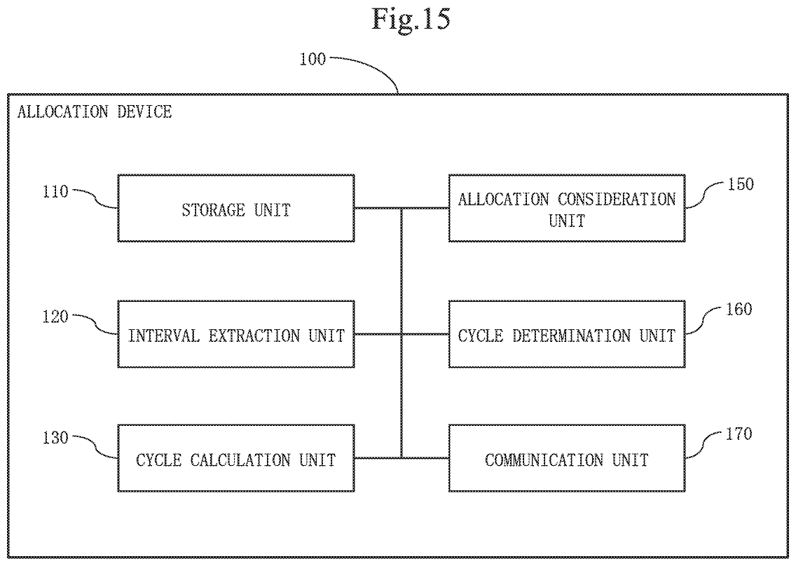

FIG. 15 illustrates an example of structure of the allocation device 100 according to the present embodiment. The allocation device 100 includes, as illustrated in the drawing, a communication unit 170.

The communication unit 170 can communicate with the learning device 200 and the inference device 300.

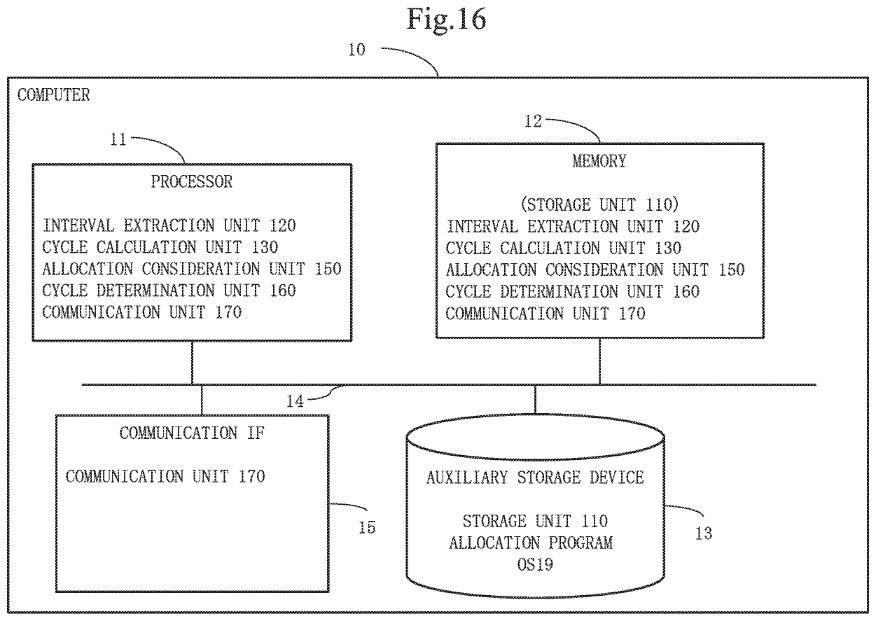

FIG. 16 illustrates an example of hardware structure of the allocation device 100 according to the present embodiment. The allocation device 100 includes, as illustrated in the drawing, a communication IF (Interface) 15.

The communication unit 170 is configured of the processor 11, the memory 12, and the communication IF 15.

The communication IF 15 is an interface for the computer 10 to perform data communication with another device and, as a specific example, an Ethernet (registered trademark) or USB (Universal Serial Bus) port. A plurality of communication IFs 15 may be present.

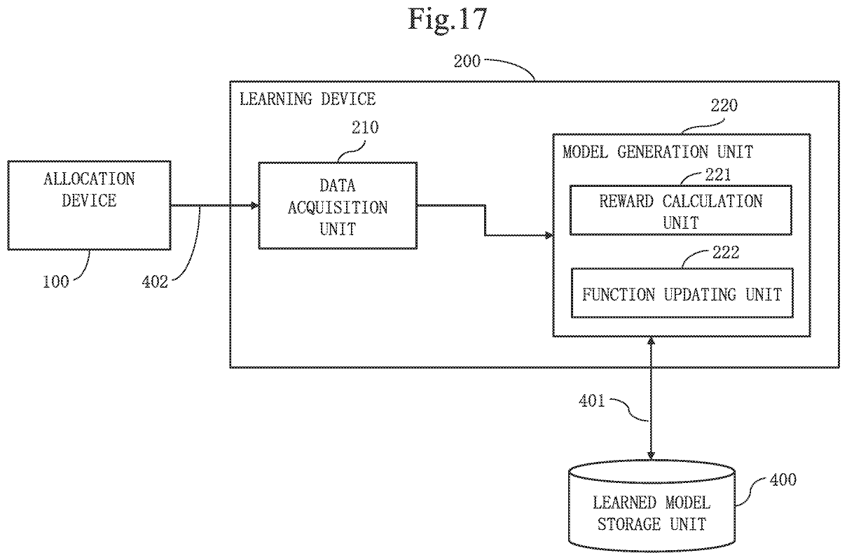

FIG. 17 illustrates an example of structure of the learning device 200 which is a machine learning device regarding the allocation device 100. The learning device 200 includes, as illustrated in the drawing, a data acquisition unit 210 and a model generation unit 220.

The data acquisition unit 210 acquires learning data 402 from the allocation device 100. The learning data 402 is data for use by the learning device 200 in learning. It is assumed that a communication plan, a plurality of communication intervals, and a plurality of communication times are included in the learning data 402, unless otherwise specified. The communication plan includes a communication cycle and information about timing for performing communication of each communication type.

As the learning data 402, the data acquisition unit 210 may acquire a plurality of communication intervals and a plurality of communication times stored in the storage unit 110 of the allocation device 100 and communication plans corresponding to the plurality of communication intervals and the plurality of communication times.

The model generation unit 220 learns, based on the learning data 402, the communication plan in a state of being inputted. That is, the model generation unit 220 generates a learned model 401 for inferring the communication plan in a state of being inputted, from the communication interval and the communication time of the allocation device 100. The state of being inputted is information about the state, from among inputted information.

By using the learning data 402, the model generation unit 220 may generate the learned model 401 for inferring the communication plan based on a plurality of communication intervals and a plurality of communication times.

As a learning algorithm, the model generation unit 220 may use a known algorithm such as supervised learning, unsupervised learning, half-supervised learning, or reinforcement learning.

By way of example, a case is described in which the learning device 200 uses reinforcement learning. In reinforcement learning, an agent (action subject) in an environment observes a current state (environmental parameter) to determine an action to be taken. The environment dynamically changes with the action of the agent. The agent is given a reward in accordance with the change of the environment. The agent repeats this to learn an action policy in which rewards can be acquired most through a series of actions. Here, the actions represent actual actions themselves. The action policy represents a way of thinking (model) for the learning device 200 to determine an action in an environment (input). As typical schemes of reinforcement learning, Q-learning and TD-learning have been known.

For example, in Q-learning, a general update formula of an action value function Q(s, a) is represented by [formula 1].

Q(sₜ, aₜ)←Q(sₜ, aₜ)+α(rₜ₊₁+γ max Q(sₜ₊₁, a)−Q(sₜ, aᵢ)) [FORMULA 1]

t represents time. sₜ represents an environment state at the time t. The environment state is formed of a communication interval and a communication time. The environment state may be formed of a communication plan. aₜ represents an action of the agent at the time t. When the agent performs the action aₜ, the state changes from sₜ to sₜ₊₁. rₜ₊₁ represents a reward given with the state changing from sₜ to sₜ₊₁. γ(0<γ≤1) is a discount factor. α(0<α≤1) represents a learning coefficient. The action at corresponds to changing the communication plan. The state sₜ corresponds to the communication interval and the communication time. The learning device 200 corresponds to the agent. The learning device 200 learns an optimum action aₜ in the state sₜ at the time t.

In the update formula represented by [formula 1], the action value Q is increased if the action value Q of the action a with the highest action value Q at a time t+1 is larger than the action value Q of the action a performed at the time t, and the action value Q is decreased in a reverse case. In other words, the learning device 200 updates the action value function Q(sₜ, aₜ) so that the action value Q of the action a at the time t approaches an optimum action value at the time t+1. With this, the optimum action value in an environment sequentially propagates to action values in environments previous to that. The action value Q has a value of the action value function.

When generating the learned model 401 by reinforcement learning, the model generation unit 220 includes a reward calculation unit 221 and a function updating unit 222.

The reward calculation unit 221 calculates a reward based on the learning data 402. The reward calculation unit 221 calculates a reward r based on the ratio of realtime communication time. For example, the reward calculation unit 221 increases the reward r for the action a (for example, gives a reward of “1”) when the ratio of realtime communication time decreases with the action a being performed, and decreases the reward r for the action a (for example, gives a reward of “−1”) when the ratio of realtime communication time increases with the action a being performed.

By following the reward calculated by the reward calculation unit 221, the function updating unit 222 updates the function for determining a communication plan in the state of being inputted, and outputs the learned model 401 to the learned model storage unit 400. For example, when the learning device 200 uses Q-learning, the action value function Q(sₜ, aₜ) represented by [formula 1] is used as a function for calculating a communication plan in the state of being inputted.

The learning as described above is repeatedly performed. The learned model storage unit 400 has stored therein the action value function Q(sₜ, aₜ) updated by the function updating unit 222, that is, the learned model 401.

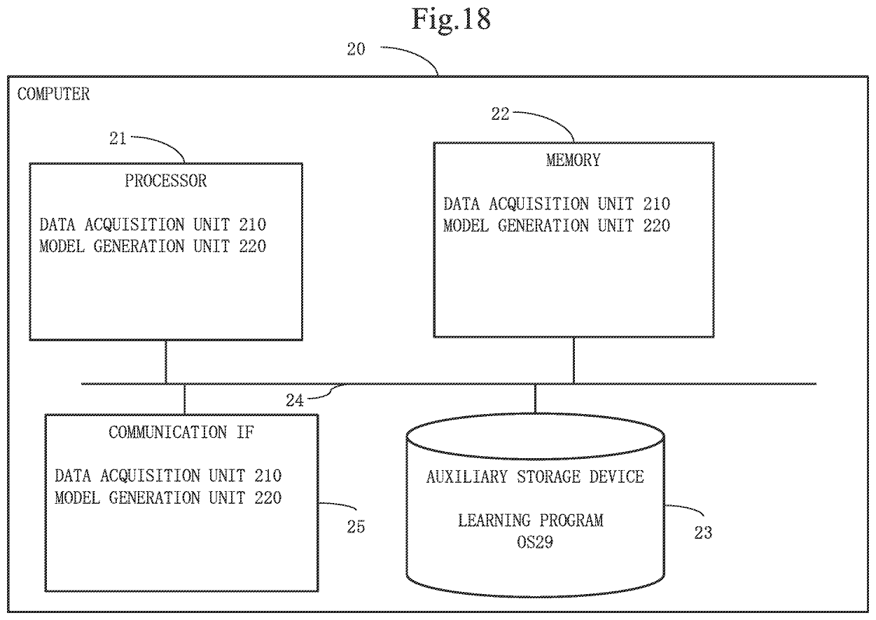

FIG. 18 illustrates an example of hardware structure of the learning device 200. The learning device 200 is configured of a computer 20. The computer 20 includes a processor 21, a memory 22, an auxiliary storage device 23, a data bus 24, and a communication IF 25. The computer 20 is equivalent to the computer 10.

Note that the computer 20 may include an electronic circuit 26. The electronic circuit 26 is equivalent to the electronic circuit 16.

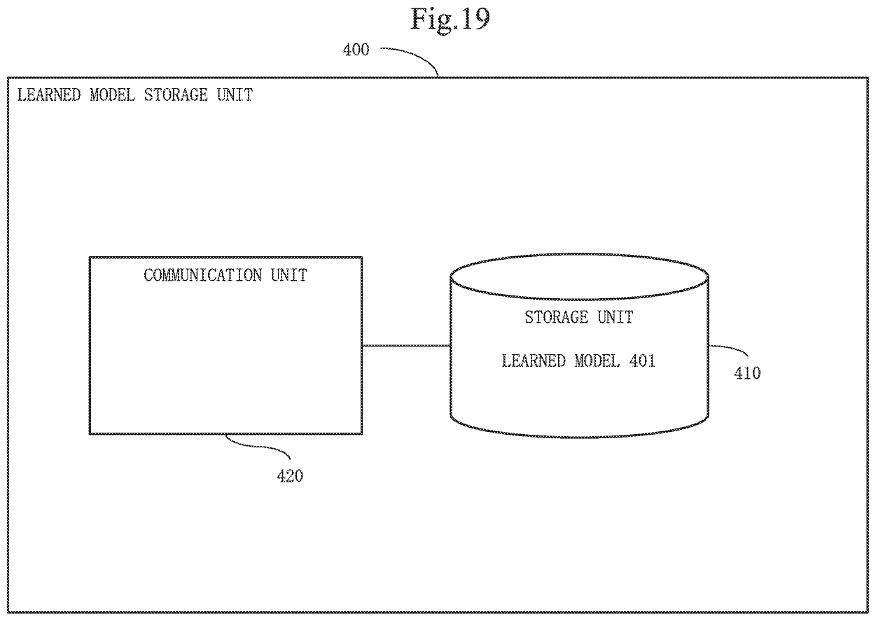

FIG. 19 illustrates an example of structure of the learned model storage unit 400. The learned model storage unit 400 is configured of, as illustrated in the drawing, a storage unit 410 and a communication unit 420.

The storage unit 410 can store the learned model 401.

The communication unit 420 can communicate with the learning device 200 and the inference device 300.

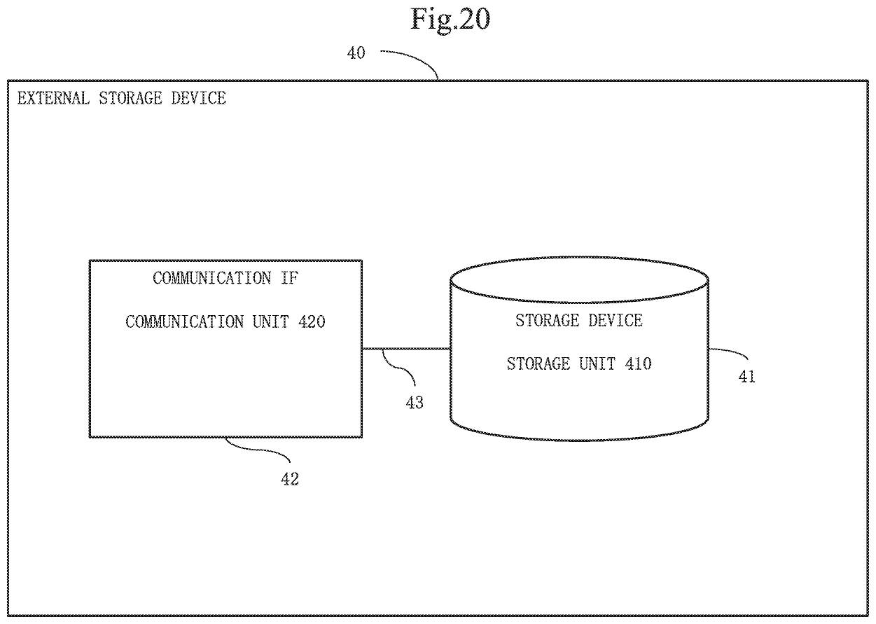

FIG. 20 illustrates an example of hardware structure of the learned model storage unit 400. The learned model storage unit 400 is configured of an external storage device 40. The external storage device 40 includes, as illustrated in the drawing, a storage device 41, a communication IF 42, and a data bus 43. The storage unit 410 is configured of the storage device 41. The communication unit 420 is configured of the communication IF 42.

The storage device 41 is equivalent to the auxiliary storage device 13.

The communication IF 42 is equivalent to the communication IF 15.

### Description of Operation

The operation procedure of the learning device 200 corresponds to a learning method. Also, a program implementing the operation of the learning device 200 corresponds to a learning program.

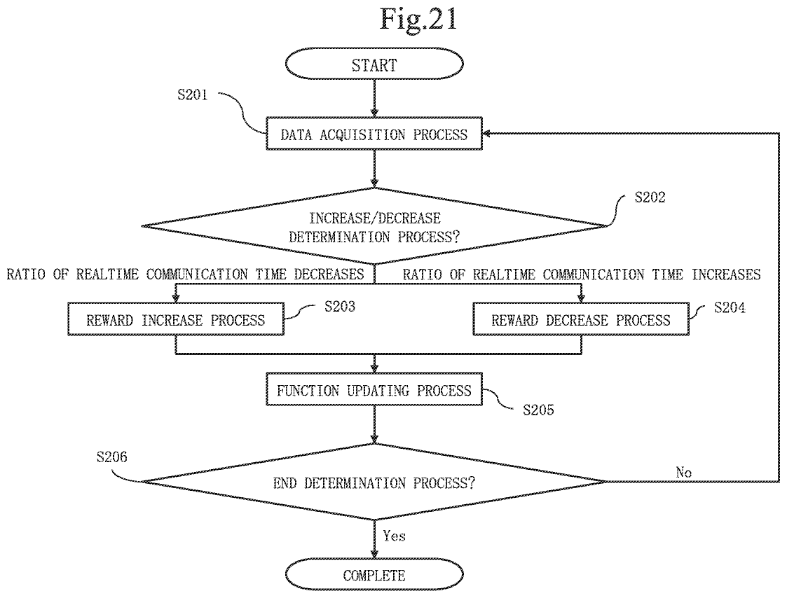

A process of the learning device 200 learning by using Q-learning is described by using FIG. 21. FIG. 21 illustrates a flowchart illustrating one example of operation of the learning process of the learning device 200. By using the drawing, the learning process is described.

### Step S201: Data Acquisition Process

The data acquisition unit 210 acquires the learning data 402 from the allocation device 100. The learning data 402 may be data corresponding to an execution log of the allocation device 100.

Also, when the learning device 200 has not finished learning all pieces of information included in the learning data 402 previously acquired by the data acquisition unit 210, the learning device 200 may proceed to the next step without acquiring the learning data 402.

### Step S202: Increase/Decrease Determination Process

The model generation unit 220 calculates a reward based on the learning data 402. Specifically, the reward calculation unit 221 acquires the learning data 402, and determines whether the reward is increased or decreased based on the ratio of realtime communication time defined in advance.

The reward calculation unit 221 proceeds to step S203 when the ratio of realtime communication time decreases. The reward calculation unit 221 proceeds to step S204 when the ratio of realtime communication time increases.

### Step S203: Reward Increase Process

The reward calculation unit 221 increases the reward.

### Step S204: Reward Decrease Process

The reward calculation unit 221 decreases the reward.

### Step S205: Function Updating Process

The function updating unit 222 updates the action value function Q(sₜ, aₜ) represented by [formula 1] stored in the learned model storage unit 400 based on the reward calculated by the reward calculation unit 221.

### Step S206: End Determination Process

The learning device 200 ends the process in the flowchart when the information included in the learning data 402 has been entirely learned. Otherwise, the learning device 200 proceeds to step S201.

The learning device 200 repeatedly performs the processes at step S201 to step S205. The learning device 200 stores the generated action value function Q(sₜ, aₜ) as the learned model 401.

Note that the learning device 200 may include the learned model storage unit 400.

### Utilization Phase

In the following, a utilization phase is described. The utilization phase is a process to be performed by the allocation device 100 and the inference device 300.

### Description of Structure

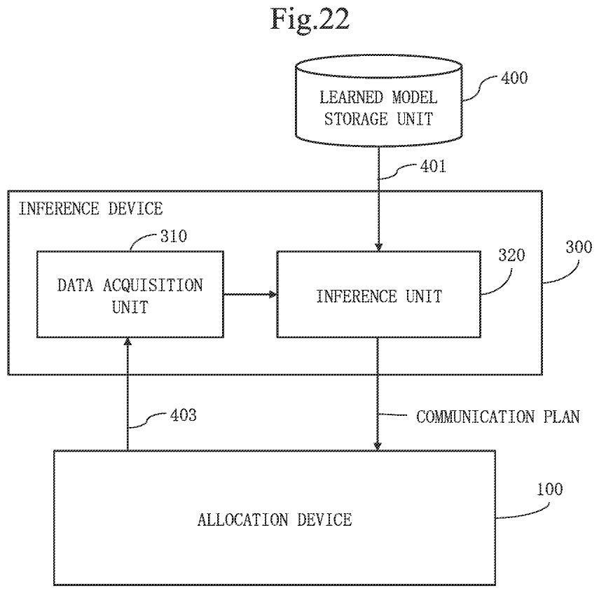

FIG. 22 illustrates an example of structure of the inference device 300, which is an inference device regarding the allocation device 100. The inference device 300 includes, as illustrated in the drawing, a data acquisition unit 310 and an inference unit 320.

The data acquisition unit 310 acquires inferring data 403 from the allocation device 100. The inferring data 403 includes a communication interval and a communication time, unless otherwise specified.

The data acquisition unit 310 acquires a plurality of communication intervals and a plurality of communication times stored in the storage unit 110 of the allocation device 100 as the inferring data 403.

The inference unit 320 infers a communication plan in a state of being inputted by using the learned model 401. That is, by inputting the communication intervals and the communication times acquired by the data acquisition unit 310 to the learned model 401, the inference unit 320 can infer a communication plan in a state of being inputted suitable for the communication intervals and the communication times.

The inference unit 320 may have stored therein the learned model 401 for inferring a communication plan indicating a period of performing each communication of the plurality of communication types indicating the types of cyclic communication. The inference unit 320 may infer a communication plan corresponding to the inferring data 403 by using the learned model 401.

Note that the inference device 300 may acquire the learned model 401 from another learning device 200 and may output a communication plan in a state of being inputted based on this learned model 401.

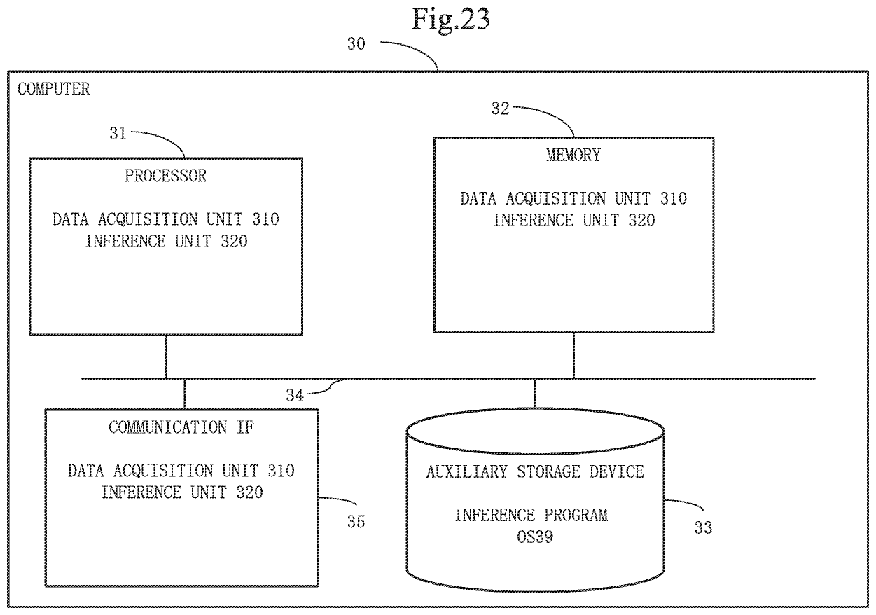

FIG. 23 illustrates an example of hardware structure of the inference device 300. The inference device 300 is formed of a computer 30, as illustrated in the drawing. The computer 30 includes a processor 31, a memory 32, an auxiliary storage device 33, a data bus 34, and a communication IF 35. The computer 30 is equivalent to the computer 10.

Note that the computer 30 may include an electronic circuit 36. The electronic circuit 36 is equivalent to the electronic circuit 16.

### Description of Operation

The operation procedure of the inference device 300 corresponds to an inference method. Also, a program implementing the operation of the inference device 300 corresponds to an inference program.

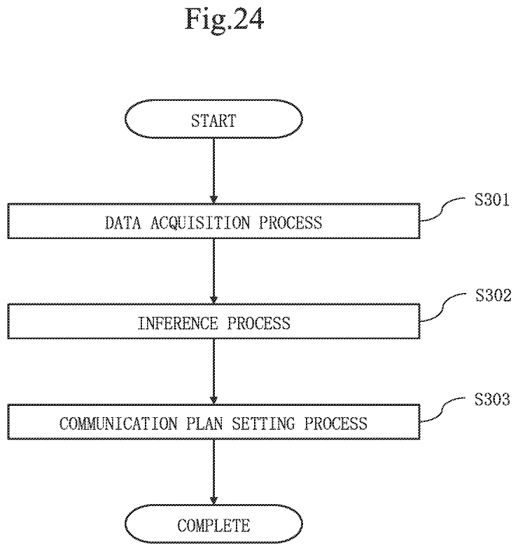

FIG. 24 is a flowchart illustrating one example of operation of the inference device 300. By using the drawing, the operation of the inference device 300 is described.

### Step S301: Data Acquisition Process

The data acquisition unit 310 acquires the inferring data 403 from the allocation device 100.

### Step S302: Inference Process

The inference unit 320 inputs the inferring data 403 to the learned model 401 stored in the learned model storage unit 400, and acquires a communication plan in a state of being inputted. The inference unit 320 outputs the acquired communication plan in the state of being inputted to the allocation device 100.

### Step S303: Communication Plan Setting Process

The allocation device 100 sets a communication plan by using the outputted communication plan in the state of being inputted.

With the process at this step, the allocation device 100 can reduce the ratio of realtime communication time.

Note that while description is made to the case in the present embodiment in which reinforcement learning is applied to the learning algorithm for use by the learning device 200, the learning algorithm for use by the learning device 200 is not limited to this. Other than reinforcement learning, the learning device 200 may use a learning algorithm such as supervised learning, unsupervised learning, or half-supervised learning.

Also, as a learning algorithm, the model generation unit 220 may use deep learning which learns to extract a feature value itself. The model generation unit 220 may perform machine learning by following another known method, such as, for example, a neural network, genetic programing, inductive logic programming, or support vector machine.

Note that the learning device 200 and the inference device 300 may be devices separate from the allocation device 100. For example, the learning device 200 and the inference device 300 may be connected to the allocation device 100 via a network. Also, the learning device and the inference device may be incorporated in the allocation device 100.

Furthermore, the learning device 200 and the inference device 300 may be present on a cloud server.

Also, the model generation unit 220 may learn a communication plan in a state of being inputted by using the learning data 402 acquired from a plurality of allocation devices 100. Note that the model generation unit 220 may acquire the learning data 402 from a plurality of allocation devices 100 for use in the same area. The model generation unit 220 may learn a communication plan in a state of being inputted by using the learning data 402 collected from a plurality of allocation devices 100 operating independently in different areas. Also, it is possible to add the allocation device 100 which collects the learning data 402 to the target in midstream or remove the allocation device 100 from the target in midstream. Furthermore, the learning device 200 which has learned the communication plan in the state of being inputted regarding one allocation device 100 may be applied to another allocation device 100 different therefrom and a communication plan in a state of being inputted regarding the other allocation device 100 may be re-learned for update.

### Description of Effects of Embodiment 2

As described above, according to the present embodiment, the allocation device 100 can use a communication plan inferred by the inference device 300.

### Other Embodiments

It is possible to freely combine the above-described respective embodiments, modify any component of each embodiment, and omit any component in each embodiment.

Also, embodiments are not limited to those described in Embodiments 1 and 2 and can be variously changed as required.

### REFERENCE SIGNS LIST

10: computer; 11: processor; 12: memory; 13: auxiliary storage device; 14: data bus; 15: communication IF; 16: electronic circuit; 19: OS; 20: computer; 21: processor; 22: memory; 23: auxiliary storage device; 24: data bus; 25: communication IF; 26: electronic circuit; 29: OS; 30: computer; 31: processor; 32: memory; 33: auxiliary storage device; 34: data bus; 35: communication IF; 36: electronic circuit; 39: OS; 40: external storage device; 41: storage device; 42: communication IF; 43: data bus; 90: allocation system; 100: allocation device; 110: storage unit; 120: interval extraction unit; 130: cycle calculation unit; 150: allocation consideration unit; 160: cycle determination unit; 170: communication unit; 200: learning device; 210: data acquisition unit; 220: model generation unit; 221: reward calculation unit; 222: function updating unit; 300: inference device; 310: data acquisition unit; 320: inference unit; 400: learned model storage unit; 401: learned model; 402: learning data; 403: inferring data; 410: storage unit; 420: communication unit

1. An allocation device, the allocation device having stored therein a base having a positive value, a plurality of communication types indicating types of cyclic communications, a plurality of communication intervals respectively indicating, for each of the plurality of communication types, upper limits of intervals in which two successive communications are performed, and an evaluation cycle indicating a communication cycle candidate in a communication plan indicating a period in which a communication of each of the plurality of communication types is performed, comprising:
processing circuitry to find a value obtained by arithmetic operation on the base, the value being a natural number equal to or less than a value obtained by dividing each of the plurality of communication intervals by a value equal to or more than the evaluation cycle, as a plurality of evaluation frequencies respectively corresponding to the plurality of communication intervals, to set a plurality of communication frequencies respectively corresponding to the plurality of communication intervals as once in a cycle indicated by each of the plurality of evaluation frequencies, and to determine the communication plan by allocating a cycle number identifying a cycle to any one communication type of the plurality of communication types, thereby performing an allocation process.

2. The allocation device according to claim 1, wherein
the processing circuitry
performs a pre-allocation process of allocating a cycle number to a communication type in which a communication frequency is once in one cycle, before performing the allocation process, and
in the allocation process, handles only the communication type corresponding to a communication frequency in which a cycle indicated by the communication frequency is equal to or more than 2.

3. The allocation device according to claim 1, wherein
the allocation device has stored therein a plurality of said evaluation cycles, and
the processing circuitry takes the base as X, takes a minimum value of the plurality of communication intervals as Cyc_min, and calculates, as the evaluation cycle, a value obtained by dividing each of the plurality of communication intervals by a power of X, the value being equal to or more than Cyc_min/(X×2) and equal to or less than Cyc_min/2.

4. The allocation device according to claim 1, wherein
the processing circuitry sets successive cycle numbers to successive cycles, uses, as the cycle number, a value equal to or more than 1 and equal to or less than a maximum value of all cycles indicated by the plurality of evaluation frequencies, respectively, and takes all of the cycles set with the cycle numbers as target cycles.

5. The allocation device according to claim 4, wherein
the allocation device has stored therein an integer equal to or more than 2 as the base and a plurality of communication times each indicating a time required for one communication of each of the plurality of communication types, and
in the allocation process, the processing circuitry finds a maximum value of values each being a power of the base and being equal to or less than a value obtained by dividing each of the plurality of communication intervals by a double of the evaluation cycle, as the plurality of evaluation frequencies; extracts, from among communication types corresponding to a maximum value of the plurality of communication times, a communication type with a maximum communication frequency corresponding to the communication type, as a target communication; assumes that a cycle indicated by the communication frequency corresponding to the target communication is C, j is an integer and 1≤j≤C, and n is an integer equal to or more than 0; in a range which j and n can take, from among cycles with a cycle number being C×n+j, extracts, as Dⱼ, a communication time of a cycle with the longest communication time; takes, as jₘᵢₙ, j corresponding to a minimum value of Dⱼ in a range which j can take; extracts, as an allocation-target communication, a communication type with no cycle number allocated; and allocates, as a cycle number, C×n+jₘᵢₙ to the allocation-target communication.

6. The allocation device according to claim 5, wherein
the allocation device has stored therein a plurality of said evaluation cycles, and
the processing circuitry finds, when the target cycle is configured of a plurality of cycles, as a plurality of provisional communication ratios, a ratio of a total of communication times occupying a time of one cycle of each cycle configuring each of the target cycles, for each of the plurality of evaluation cycles, based on the cycle numbers allocated to the plurality of communication types, respectively; finds, as a plurality of communication ratios, a maximum value of the plurality of provisional communication ratios for each of the plurality of evaluation cycles; and takes an evaluation cycle corresponding to a minimum value of the plurality of communication ratios as a communication cycle of the communication plan.

7. The allocation device according to claim 6, wherein
when n is an integer equal to or more than 0, i is an integer equal to or more than 2, C is X\hat{ }i, k is an integer and 1≤k≤X\hat{ }(i−1), and a remainder of division of k by X\hat{ }(i−1) and a remainder of division of j by X\hat{ }(i−1) do not match, after performing the allocation process, the processing circuitry performs a post-allocation process of taking, as a selected type, any communication type with a cycle being equal to or more than X\hat{ }i and with no cycle number allocated and allocating, as a cycle number, (X\hat{ }i)×n+X\hat{ }(i−1)+jₘᵢₙ to the selected type.

8. The allocation device according to claim 7, wherein
in the post-allocation process, the processing circuitry allocates a cycle number to the selected type so that the total of communication times does not exceed a maximum value of a total of communication times of cycles with a cycle number being (X\hat{ }i)×n+jₘᵢₙ in a range which n can take.

9. A learning device comprising:
processing circuitry:
to acquire, as learning data, the plurality of communication intervals and the plurality of communication times stored in the allocation device according to claim 5 and a communication plan indicating the period in which the communication of each of the plurality of communication types indicating types of cyclic communications is performed, the communication plan corresponding to the plurality of communication intervals and the plurality of communication times; and
to generate, by using the learning data, a learned model for inferring a communication plan based on the plurality of communication intervals and the plurality of communication times.

10. An inference device comprising:
processing circuitry:
to acquire, as inferring data, the plurality of communication intervals and the plurality of communication times stored in the allocation device according to claim 5, wherein
the inference device has stored therein a learned model for inferring a communication plan indicating the period in which the communication of each of the plurality of communication types indicating types of cyclic communications is performed,
the processing circuitry infers a communication plan corresponding to the inferring data by using the learned model.

11. An allocation method, comprising:
having stored a base having a positive value, a plurality of communication types indicating types of cyclic communications, a plurality of communication intervals respectively indicating, for each of the plurality of communication types, upper limits of intervals in which two successive communications are performed, and an evaluation cycle indicating a communication cycle candidate in a communication plan indicating a period in which a communication of each of the plurality of communication types is performed, and
finding a value obtained by arithmetic operation on the base, the value being a natural number equal to or less than a value obtained by dividing each of the plurality of communication intervals by a value equal to or more than the evaluation cycle, as a plurality of evaluation frequencies respectively corresponding to the plurality of communication intervals, setting a plurality of communication frequencies respectively corresponding to the plurality of communication intervals as once in a cycle indicated by each of the plurality of evaluation frequencies, and determining the communication plan by allocating a cycle number identifying a cycle to any one communication type of the plurality of communication types, thereby performing an allocation process.

12. A non-transitory computer readable medium storing an allocation program that causes a computer having stored therein a base having a positive value, a plurality of communication types indicating types of cyclic communications, a plurality of communication intervals respectively indicating, for each of the plurality of communication types, upper limits of intervals in which two successive communications are performed, and an evaluation cycle indicating a communication cycle candidate in a communication plan indicating a period in which a communication of each of the plurality of communication types is performed
to find a value obtained by arithmetic operation on the base, the value being a natural number equal to or less than a value obtained by dividing each of the plurality of communication intervals by a value equal to or more than the evaluation cycle, as a plurality of evaluation frequencies respectively corresponding to the plurality of communication intervals; to set a plurality of communication frequencies respectively corresponding to the plurality of communication intervals as once in a cycle indicated by each of the plurality of evaluation frequencies; and to determine the communication plan by allocating a cycle number identifying a cycle to any one communication type of the plurality of communication types, thereby performing an allocation process.
